(19) United States
(12) Patent Application Publication
(10) Pub. No.: US 2015/0104149 A1
(43) Pub. Date: Apr. 16, 2015

(54) VIDEO SUMMARY APPARATUS AND METHOD

(71) Applicant: Electronics and Telecommunications Research Institute, Daejeon (KR)

(72) Inventors: JAE CHEOL SIM, Daejeon (KR); HWA SUK KIM, Daejeon (KR)

(21) Appl. No.: 14/514,929

(22) Filed: Oct. 15, 2014

(30) Foreign Application Priority Data
Oct. 15, 2013 (KR) 10-2013-0122700
Jun. 23, 2014 (KR) 10-2014-0076758

(51) Int. Cl. G06K 9/00; G11B 27/34; G11B 27/06

(52) U.S. Cl. CPC G06K 9/00751; G11B 27/06; G11B 27/34
USPC 386/241

(57) ABSTRACT

A video summary apparatus and method. The video summary apparatus according to an exemplary embodiment includes: an object extractor to extract an object by separating a background from each of original frames included in a video for a predetermined time; an object analyzer to analyze, according to an original frame sequence, the object extracted by the object extractor and identify noticeable characteristics of time-lapse variation of the object; and a summary image generator to generate a summary image including an indication symbol that visualizes the noticeable characteristics of the object identified by the object analyzer.

### CROSS-REFERENCE TO RELATED APPLICATION(S)

This application claims the benefit under 35 U.S.C. §119(a) of Korean Patent Application Nos. 10-2013-0122700, filed on Oct. 15, 2013, and 10-2014-0076758, filed on Jun. 23, 2014, in the Korean Intellectual Property Office, the entire disclosures of which are incorporated herein by references for all purposes.

### BACKGROUND

1. Field

The following description relates to image processing technology, and more specifically, to a video summary apparatus and method, which analyzes a video and generates summary images.

2. Description of the Related Art

Recently, a quantity of information generated into multimedia data, such as video and voice data, is explosively increasing due to rapid development of electronic and communications technology, development of camera technology, and dissemination of smartphones. Accordingly, in using the multimedia data, an increasing trend is a demand for technology of precisely and quickly extracting information that a user wants.

A closed circuit television (CCTV) enables videos to be connected through wired or wireless networks and be transmitted or received, and the videos are set not to be received except by designated recipients. The CCTV is occasionally called ITV, which is the abbreviation of Industrial Television, and has multiple uses, such as industrial, educational, medical, traffic control monitoring, disaster preventing, and in-company video information delivering ITVs, etc. In other words, a CCTV system and a Video Management System (VMS), etc., are systems for monitoring, in real time, videos collected through cameras, storing the videos, and checking the videos through playback if necessary, and are used as monitoring means capable of actively identifying and tracking monitored targets through the videos.

However, currently most video surveillance systems have big problems in consumption of cost and manpower because monitors or observers are required to directly watch videos coming through cameras with naked eyes for a long time. As one way to solve these problems, video summary technology is attempted to effectively perform playing and monitoring of videos stored for a long time, and determination of unusual situations.

On the other hand, the current video summary technology is provided in a form of generating shortened videos by overlapping videos of different points of view, which results in a problem of directly watching the videos with naked eyes during the play time of the shortened videos. In addition, it is difficult to understand situations and ascertain unusual situations in the shortened videos that include a plurality of objects simultaneously moving.

### SUMMARY

Provided is a video summary apparatus and method for intuitively understanding situations.

Provided is a video summary apparatus and method for checking an object that monitors or observers are required to focus on.

Provided is a video summary apparatus and method for analyzing a movement path, a movement speed, a size, an appearance, and a disappearance, and for checking events that the monitors or observers are required to focus on with regard to the object.

Provided is a video summary apparatus and method for easily searching a video of the object within an image to play the video.

Accordingly, the situations may be intuitively understood by summarizing a video for a predetermined time into one image that includes noticeable characteristics of time-lapse variation of the object.

The events that the monitors or observers are required to focus on may be checked by summarizing the video for a predetermined time into one image that includes the noticeable characteristics of time-lapse variation of the object and thereby analyzing a movement path of the object, a movement speed, a size, an appearance, and a disappearance, etc.

In a case in which there is a plurality of the objects within the video for a predetermined time, the objects that the monitors or observers are required to focus on may be checked by making an unnatural object exposed rather than a normal object whose noticeable characteristics are overlapped, through an analysis of the noticeable characteristics of time-lapse variation between the objects.

The video of the object within a summary image may be easily searched and played by summarizing the video for a predetermined time into one image that includes the noticeable characteristics of time-lapse variation of the object

In a general aspect, the video summary apparatus includes: an object extractor to extract an object by separating a background from original frames, respectively, of a video for a predetermined time; an object analyzer to analyze, according to an original frame sequence of the original frames, the object extracted by the object extractor and identify noticeable characteristics of time-lapse variation of the object; and a summary image generator to generate a summary image including an indication symbol that visualizes the noticeable characteristics of the object identified by the object analyzer.

The noticeable characteristics may include one or more of a movement path, a movement speed, a size, an appearance, and a disappearance. Alternatively, the indication symbol may be expressed by using one or more of: a trace line that indicates a movement path of the object; an arrow that indicates a movement direction of the object; a thickness of a line that indicates a movement speed of the object; and figures that indicate an appearance, disappearance, and size of the object. Alternatively, the summary image generator may generate the summary image by setting a time point, in which the noticeable characteristics of the object are changed, as a standard time point for generating the summary image.

The video summary apparatus may further include a video player to play the original frame sequence where the object is included, in response to selection of the object within the generated summary image.

The video summary apparatus may further include, in a case where there is a plurality of objects extracted by the object extractor: an object frame sequence synthesizer to synthesize a frame sequence of each of the plurality of the objects and a frame sequence of the background so as to generate a synthesis frame sequence, wherein the object analyzer analyzes each of the plurality of the extracted objects according to the original frame sequence or the synthesis frame sequence and identify the noticeable characteristics of each of the plurality of objects; and wherein the video summary image generator generates a summary image including an indication symbol that visualizes the identified noticeable characteristics of each of the plurality of objects. In such a case, in a case where there is the plurality of objects extracted by the object extractor, the noticeable characteristics may include the noticeable characteristics of an unnatural object, which are different from the noticeable characteristics of other objects. Alternatively, in a case where there is the plurality of objects extracted by the object extractor, changes of the noticeable characteristics may be similar to be overlapped such that the indication symbol is blurred.

The video summary apparatus may further include a video player to, in response to a selection of a specific object within the generated summary image, play one of the synthesis frame sequence and the original frame sequence that includes the object with regard to the specific object.

In another general aspect, a video summary method includes: (a) extracting an object by separating a background from original frames, respectively, of a video for a predetermined time; (b) analyzing, according to an original frame sequence of the original frames, the object extracted by the object extractor and identifying noticeable characteristics of time-lapse variation of the object; and (c) generating a summary image including an indication symbol that visualizes the identified noticeable characteristics of the object.

The noticeable characteristics of time-lapse variation may include one or more of a movement path, a movement speed, a size, an appearance, and a disappearance. Alternatively, the indication symbol may be expressed by using one or more of: a trace line that indicates a movement path of the object; an arrow that indicates a movement direction of the object; a thickness of a line that indicates a movement speed of the object; and figures that indicate an appearance, disappearance, and size of the object. Alternatively, (c) may include generating the summary image by setting a time point, in which the noticeable characteristics of the object are changed, as a standard time point for generating the summary image.

The video summary method may further include (e) playing the original frame sequence where the object is included, in response to selection of the object within the generated summary image.

The video summary method may further include, prior to (b), in a case where there is a plurality of objects extracted in (a): (d) synthesizing a frame sequence of each of the plurality of objects and a frame sequence of the background so as to generate a synthesis frame sequence, wherein (b) comprises analyzing each of the plurality of extracted objects according to the original frame sequence or the synthesis frame sequence and identifying the noticeable characteristics of each of the plurality of objects, and wherein (c) comprises generating the summary image including an indication symbol that visualizes the identified noticeable characteristics of each of the plurality of objects. In such a case, in a case where there is the plurality of objects extracted by the object extractor, the noticeable characteristics may include the noticeable characteristics of an unnatural object, which are different from the noticeable characteristics of other objects. Alternatively, in a case where there is the plurality of objects extracted by the object extractor, changes of the noticeable characteristics may be similar to be overlapped such that the indication symbol is blurred.

Alternatively, the video summary method may further include (e) in response to a selection of a specific object within the generated summary image, playing one of the synthesis frame sequence and the original frame sequence that includes the object with regard to the specific object.

Alternatively, the video summary method may further include, prior to (a), determining a predetermined time in response to a request for generating the summary image for a predetermined time interval.

In another general aspect, a computer-readable storage media may include a program recorded for executing a video summary method in a computer.

### BRIEF DESCRIPTION OF THE DRAWINGS

FIG. 1 is a diagram illustrating a video summary system in a Closed Circuit Television (CCTV) environment according to an exemplary embodiment.

FIG. 2 is a schematic diagram illustrating a video summary apparatus according to an exemplary embodiment.

FIG. 3 is a schematic diagram illustrating a video summary apparatus according to another exemplary embodiment.

FIG. 4 is a flowchart illustrating a video summary method according to an exemplary embodiment.

FIG. 5 is a flowchart illustrating a video summary method according to another exemplary embodiment.

FIG. 6 is a flowchart illustrating a video summary method according to yet another exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

Unless the context clearly indicates otherwise, as used herein plural forms of the terms herein are to be construed as including the singular form and vice versa.

The terms “comprises” and/or “comprising” as used herein will be understood to mean that the list following is non-exhaustive and may or may not include any other additional suitable items, for example one or more further component(s), operation(s), procedure(s), and/or element(s) as appropriate.

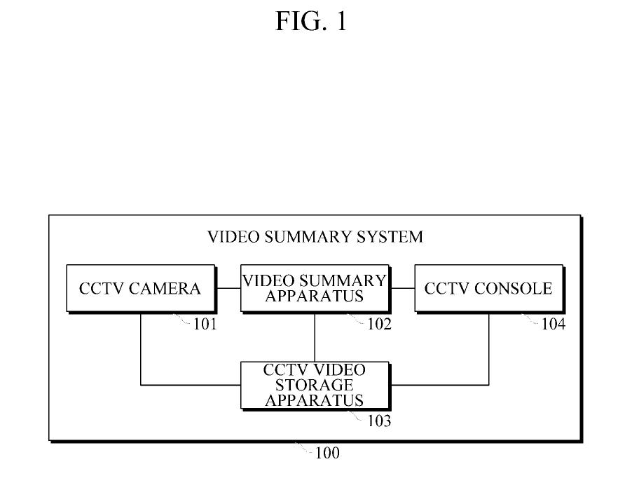

First, FIG. 1 is a diagram illustrating a video summary system in a Closed Circuit Television (CCTV) environment according to an exemplary embodiment.

The present disclosure may aim at generating one summary image to effectively perform determinations of unusual situations in videos acquired for a long time, and preferably, summarizing videos acquired from a closed circuit television (CCTV) camera or videos of a video management system (VMS); however, exemplary embodiments are not limited thereto. For example, the camera, such as CCTV, has a feature of acquiring videos with the same background for a long time. Thus, the CCTV videos recorded for a long time may be understood and checked within a short time through the generation of one summary image by a video summary apparatus.

Referring to FIG. 1, a video summary system 100 of a CCTV environment may include a CCTV camera 101, a video summary apparatus 102, a CCTV video storing apparatus 103, and a CCTV console 104.

The CCTV camera 101 may provide a function of acquiring videos. Preferably, the CCTV camera 101 may acquire videos with the same background for a long time.

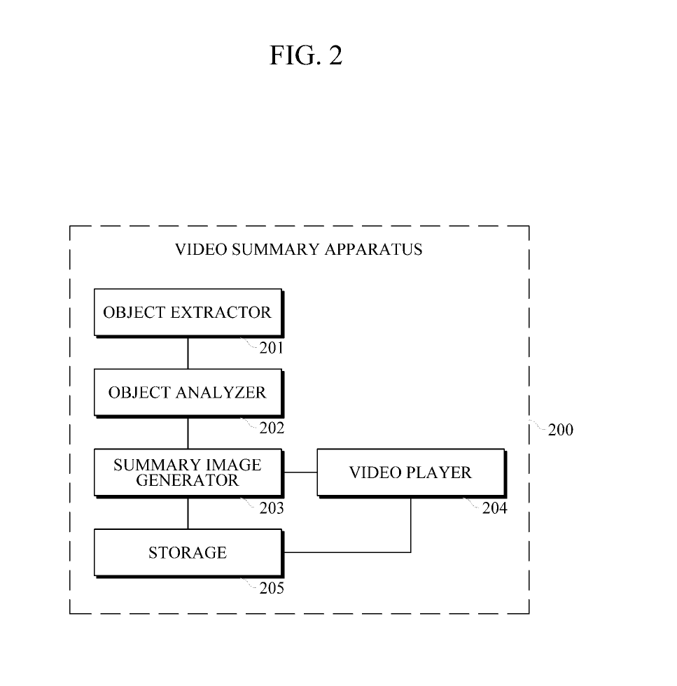

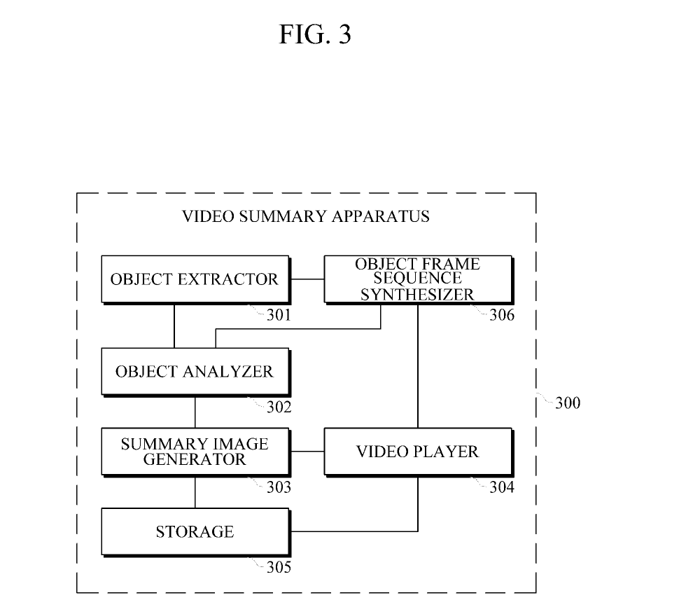

The video summary apparatus 102 provides a function of separating backgrounds and objects of videos acquired from the CCTV camera and generating a summary image through an analysis of the objects. The video summary apparatus 102 is specifically described later with reference to FIGS. 2 and 3.

The CCTV video storage apparatus 103 provides a function of storing videos acquired from the CCTV camera, analyzed object information, or generated summary image. The CCTV video storage apparatus 103 may be included as an additional apparatus in the video summary system of the CCTV environment, and also be included as a partial component in the video summary apparatus as described below.

The CCTV console 104 provides a function of basically monitoring and observing the CCTV, outputting the summary image generated by the video summary apparatus or stored in the CCTV video storage apparatus, and playing the original video. The CCTV console 104 commonly indicates all kinds of devices capable of playing the videos with a display.

The video summary system 100 illustrated in FIG. 1 is only an exemplary embodiment, and may also be equipped with a part of the components illustrated in FIG. 1 and/or additionally with other essential components for the operations. Hereinafter, the video summary apparatus 200 and 300 included in a part of the video summary system 100 are described referring to FIGS. 2 and 3.

FIG. 2 is a schematic diagram illustrating a video summary apparatus according to an exemplary embodiment.

Referring to FIG. 2, a video summary apparatus 200 may include an object extractor 201, an object analyzer 202, a summary image generator 203, a video player 204, and storage 205. The video summary apparatus 200 and 300 illustrated in FIGS. 2 and 3 are only exemplary embodiments, and may also be equipped with a part of modules illustrated in FIGS. 2 and 3 and/or additionally with other essential modules for the operations.

The object extractor 201 provides a function of extracting objects by separating a background from each original frame that forms a video for a predetermined time. Here, the ‘object’ indicates a person or thing existing in the real world, and a thing other than the background among elements of the video frames. For example, in video frames acquired through a CCTV camera installed in a parking lot, internal structures or installations of the parking lot, etc., may be the backgrounds. Also, a vehicle and a person within the acquired video frame may be the object. That is, vehicles moving for parking or out of the parking lot, and vehicles parked or stopped, etc., may be the objects. However, depending on the case, the vehicles parked or stopped may be the backgrounds.

‘Extracting an object’ indicates identifying the objects and the backgrounds from the original frames of the videos, and selecting the object that is a target to be analyzed. According to an exemplary embodiment, there is no limit to an object extracting method, and the object extractor may use a foreground and background separation algorithm, etc. Generally, for the background separation, there is a method, and the like, of comparing pixel values of the images acquired from a previous frame and pixel values of the images acquired from the current frame, and other well-known algorithms, etc., may also be used, to which exemplary embodiments are not limited.

The object analyzer 202 provides a function of analyzing the objects extracted by the object extractor 201 according to an original frame sequence and identifying noticeable characteristics of time-lapse variation of the objects. Here, the ‘noticeable characteristics of time-lapse variation’ indicates noticeable characteristics of visible changes, such as static or dynamic characteristics of the objects existing in the videos for a predetermined time. For example, the noticeable characteristics of time-lapse variation may include a size of the object as the static characteristic; a movement path, a movement speed of the object, and an appearance and a disappearance of the object as the dynamic characteristic; and may also include characteristics showing the static or dynamic visible changes of the object. That is, the object analyzer 202 may identify the visible changes of the object by the lapse of time, such as the size of the object, the movement path, the movement speed is, whether the object appears or disappears, and the like, in the original frame sequence with regard to the extracted objects.

The summary image generator 203 provides a function of generating a summary image that includes indication symbols on an object, which visualize the noticeable characteristics of time-lapse variation of the objects identified by the object analyzer 202. In such a case, the summary image generator 203 may set a point in time, in which the noticeable characteristics of time-lapse variation of the object are changed, as a standard point in time for generating the summary image so that the summary image may be generated.

Here, the ‘indication symbol’ indicates visible means, such as predetermined figure or mark indicating the noticeable characteristics of time-lapse variation of the object. For example, the indication symbol may be expressed by using one or more of a trace line that indicates a movement path of the object, an arrow that indicates a movement direction of the object, a thickness of a line that indicates a movement speed of the object, a figure that indicates an appearance of the object, a figure that indicates a disappearance of the object, and a figure that indicates a size of the object. Also, a method of expressing the indication symbol may vary, and exemplary embodiments are not limited thereto.

In other words, in order to express the movement path of the object in the summary image that is to be generated, by setting, as a standard, an object at a standard time point to generate the summary image and leaving an image of the object as one, the movement path of the object may be expressed with a line that starts from the object, that is, the trace line. In addition, in a case where the movement speed of the object is fast, the thickness of the trace line may be expressed boldly, or in a case where the movement speed of the object is slow, the thickness of the trace line may be expressed finely.

The summary image may include indication symbols with regard to some parts of the noticeable characteristics of time-lapse variation, such as a movement path summary of the object, a movement speed summary of the subject, an appearance summary of the object, or a disappearance summary of the object, etc., according to situations, and be generated.

The video player 204 provides a function of playing the original frame sequence where the object is included if the object within the generated summary image is selected. For example, the video player 204 may play the original frame sequence of a video from a time point when the object appears until a time point when the object disappears, or play the original frame sequence of the video of a predetermined time, which has been a basis of the summary image generation.

The storage 205 stores temporarily or permanently the summary image generated by the summary image generator 203. The storage 205 may have stored the original frame sequence of the video.

FIG. 3 is a schematic diagram illustrating a video summary apparatus according to another exemplary embodiment.

Referring to FIG. 3, a video summary apparatus 300 may include an object extractor 301, an object analyzer 302, a summary image generator 303, a video player 304, storage 305, and an object frame sequence synthesizer 306.

There is a difference between the video summary apparatus 300 illustrated in FIG. 3 and a video summary apparatus 200 illustrated in FIG. 2 in that the video summary apparatus 300 further includes the object frame sequence synthesizer 306. Hereinafter, the video summary apparatus 300 in FIG. 3 is described based on the difference between itself and the video summary apparatus 200. Thus, details of the description related to the video summary apparatus 200 in FIG. 2 may be applied to details not described specifically related to the video summary apparatus 300 in FIG. 3 except cases where the application is not available due to essential properties of each component.

The object frame sequence synthesizer 306 provides a function of generating a synthesis frame sequence for each of a plurality of objects in a case where there is a plurality of the objects extracted by the object extractor 301. Here, ‘generating the synthesis frame sequence for each of the plurality of the objects’ indicates synthesizing the frame sequence of each of the plurality of the objects and the frame sequence of the background for each of the plurality of the objects extracted by the object extractor 301.) Thus, a plurality of the synthesis frame sequences is generated for each of the plurality of the objects.

The object analyzer 302 provides a function of analyzing, for each of the plurality of the objects, the objects extracted by the object extractor 301 according to the original frame sequence and identifying the noticeable characteristics of time-lapse variation of the object.) Alternatively, the object analyzer 302 may analyze, for each of the plurality of the objects, the objects extracted by the object extractor 301 according to the synthesis frame sequence that is synthesized by the object frame sequence synthesizer 306, and identify the noticeable characteristics of time-lapse variation of the object.

In such a case, the ‘noticeable characteristics of time-lapse variation’ may indicate characteristics of visible changes, such as static or dynamic characteristics of the objects existing in the video for a predetermined time, as well as the noticeable characteristics of time-lapse variation of an unnatural object. Here, the ‘unnatural object’ indicates an object that shows the noticeable characteristics of time-lapse variation that are different from ones of other objects among the plurality of objects. For example, in a case where there is a plurality of extracted objects, if only one of the plurality of objects moves on a different path from other objects, the only one object may be called the unnatural object. Here, the moving on the different movement path from other objects is the noticeable characteristics of time-lapse variation between the plurality of objects.

The summary image generator 303 provides a function of generating a summary image including indication symbols with regard to the plurality of the objects that visualizes the noticeable characteristics of time-lapse variation of each of the plurality of the objects identified by the object analyzer 302, for each of the plurality of objects.

In such a case, the ‘indication symbol’ may be expressed as a trace line that indicates a movement path of the object, an arrow that indicates a movement direction of the object, a thickness of a line that indicates a movement speed of the object, a figure that indicates an appearance of the object, a figure that indicates a disappearance of the object, and a figure that indicates a size of the object. Also, the ‘indication symbol’ may be expressed in a manner of blurring the object in a case where changes of the noticeable characteristics of time-lapse variation of each of the plurality of objects are similar to thereby be overlapped, but the method may be expressed in various manners, and exemplary embodiments are not limited thereto. In the exemplary embodiment above, since the movement paths of other objects are similar to be overlapped, the indication symbol may be expressed by blurring other objects. Then, the movement path of the unnatural object, i.e., one object that moves on a different path from other objects, may be shown precisely so that monitors or observers may intuitively check objects to be focused on.

The video player 304 provides a function of playing the original frame sequence that includes a specific object if the specific object is selected among the plurality of objects within the generated summary image. Alternatively, the video player 304 may provide a function of playing the synthesis frame sequence with regard to the specific object. For example, the video player 304 may play the original frame sequence of the video of a time point when the specific object appears until a time point when the specific object disappears, play the original frame sequence of the video of a predetermined time that has been a basis of the summary image generation, or play the synthesis frame sequence generated with regard to the specific object.

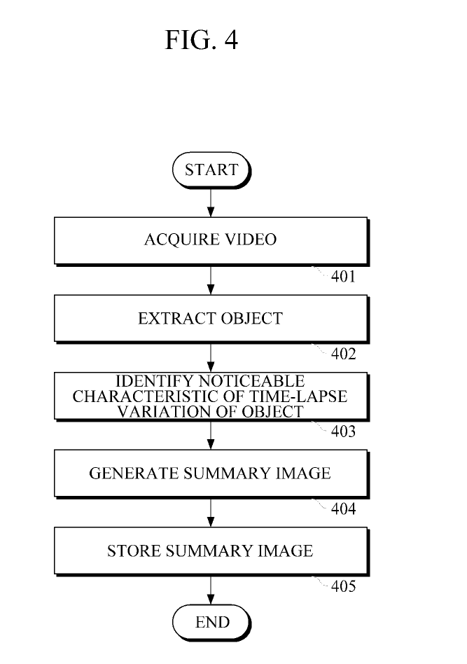

FIG. 4 is a flowchart illustrating a video summary method according to an exemplary embodiment. Processes described hereinafter including the exemplary embodiment may possibly be implemented in various forms.

The video summary method illustrated in FIG. 4 may be a method for summarizing a video by using a video summary apparatus 200 in FIG. 2 or an electronic device equipped therewith.

Referring to FIG. 4, videos are first acquired in 401. Although the videos may be acquired through electronic devices, such as a digital camera or a camcorder, which have main functions of filming images, exemplary embodiments are not limited thereto. Preferably, the videos may be acquired through the CCTV camera for monitoring and observing for a long time.

Then, the background is separated from each original frame included in the videos of a predetermined time so that objects are extracted in 402. Here, the ‘object’ and the ‘object extraction’ are described above in detail with reference to FIG. 2. Also, in an exemplary embodiment, there is no particular limit to an object extraction method, and an object extractor may use a foreground and background separation algorithm, etc., for the object extraction. Generally, for the background separation, there is a method, and the like, of comparing pixel values of the images acquired from a previous frame and pixel values of the images acquired from the current frame, and other well-known algorithms, etc., may also be used, to which exemplary embodiments are not limited.

Then, the extracted objects are analyzed according to an original frame sequence so that the noticeable characteristics of time-lapse variation of the objects are identified in 403. Here, the ‘noticeable characteristics of time-lapse variation’ may indicate characteristics of visible changes, such as static or dynamic characteristics of objects existing within a video for a predetermined time. For example, the noticeable characteristics of time-lapse variation may include a size of the object as the static characteristic; a movement path, a movement speed of the object, and an appearance and a disappearance of the object as the dynamic characteristic; and may also include characteristics showing the static or dynamic visible changes of the object.

That is, the visible changes of the object may be identified by the lapse of time, such as the size of the object, the movement path, the movement speed, the object appearance or disappearance, and the like, in the original frame sequence with regard to the extracted objects.

Then, the summary image is generated in 404, which includes indication symbols that visualize the identified noticeable characteristics of time-lapse variation of the object. In such a case, a point in time in which the noticeable characteristics of time-lapse variation of the object are changed may be set as a standard time point for generating the summary image so that the summary image may be generated.

Here, the ‘indication symbol’ indicates visible means, such as predetermined figure or mark indicating the noticeable characteristics of time-lapse variation of the object. For example, the indication symbol may be expressed by using one or more of a trace line that indicates a movement path of the object, an arrow that indicates a movement direction of the object, a thickness of a line that indicates a movement speed of the object, a figure that indicates an appearance of the object, a figure that indicates a disappearance of the object, and a figure that indicates a size of the object. Also, a method of expressing the indication symbol may vary, and exemplary embodiments are not limited thereto.

In other words, in order to express the movement path of the object in the summary image that is to be generated, by setting, as a standard, an object at a standard time point to generate the summary image and leaving an image of the object as one, the movement path of the object may be expressed with a line that starts from the object, that is, the trace line. In addition, in a case where the movement speed of the object is fast, the thickness of the trace line may be expressed boldly, or in a case where the movement speed of the object is slow, the thickness of the trace line may be expressed finely.

The summary image may include indication symbols with regard to some parts of the noticeable characteristics of time-lapse variation, such as a movement path summary of the object, a movement speed summary of the subject, an appearance summary of the object, or a disappearance summary of the object, etc., according to situations, and be generated.

Then, the generated summary image is stored in 405. The generated summary image may be temporarily or permanently stored in storage media, etc.

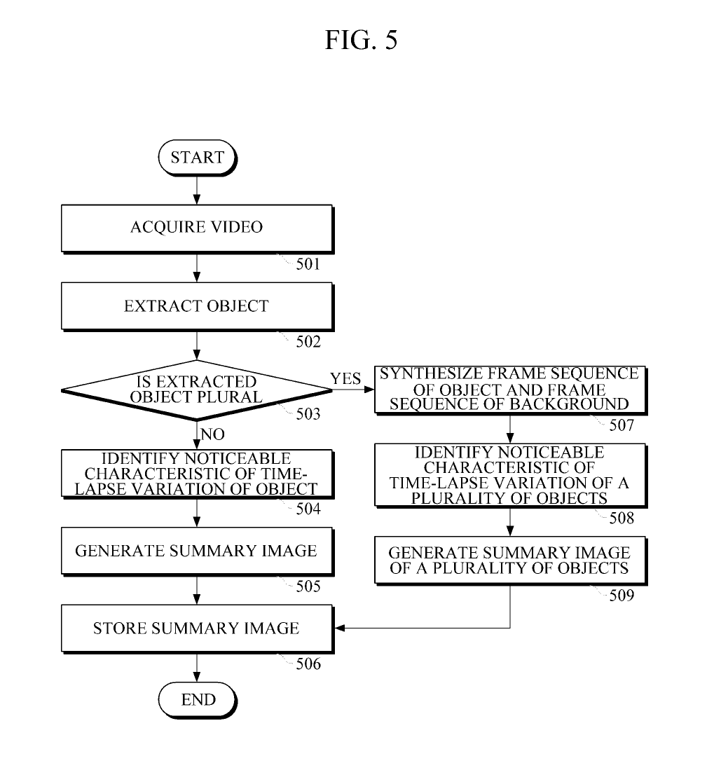

FIG. 5 is a flowchart illustrating a video summary method according to another exemplary embodiment.

The video summary method illustrated in FIG. 5 may be a method for summarizing a video by using a video summary apparatus 300 in FIG. 3 or an electronic device equipped therewith. There is a difference between the video summary apparatus 300 illustrated in FIG. 3 and a video summary apparatus 200 illustrated in FIG. 2 in that the video summary apparatus 300 further includes an object frame sequence synthesizer 306. A video summary method illustrated in FIG. 4 may be a method for summarizing a video by using a video summary apparatus 200 in FIG. 2 or an electronic device equipped therewith. Hereinafter, the video summary method in FIG. 5 is described based on the difference between itself and the video summary method. Accordingly, to avoid unnecessary repetition, the video summary method is described briefly, and the description with reference to FIGS. 2, 3, and 4 may be equally applied to FIG. 5. In other words, FIG. 5 is a flowchart illustrating a video summary method in a case where there is a plurality of objects within the video.

Referring to FIG. 5, first a video is acquired in 501, and a background is separated from each original frame that includes a video of a predetermined time so that the object is extracted in 502.

Then, it is determined whether there is a plurality of the extracted objects in 503.

If the object extracted in operation 503 has been determined not to be a plurality, the description with reference to FIG. 4 may be equally applied to FIG. 5. That is, the extracted object is analyzed according to the original frame sequence so that noticeable characteristics of time-lapse variation of the object is identified in 504, then the summary image is generated in 505 including indication symbols that visualizes the identified noticeable characteristics of time-lapse variation of the object. Then, the generated summary image is stored in 506.

Otherwise, if it has been determined that there is a plurality of objects extracted in operation 503, the frame sequence of each of the plurality of objects is synthesized with the frame sequence of a background for each of the plurality of objects so that a synthesis frame sequence for each object is generated in 507. Here, the ‘generation of the synthesis frame sequence’ is described specifically with reference to FIG. 3 above.

Then, the object extracted for each of the plurality of the objects is analyzed according to the original frame sequence so that the noticeable characteristics of time-lapse variation of the object are identified in 508. Alternatively, the object extracted for each of the plurality of the objects is analyzed according to the synthesis frame sequence acquired from synthesizing the objects extracted for each of the plurality of objects so that the noticeable characteristics of time-lapse variation may be identified.

In such a case, the ‘noticeable characteristics of time-lapse variation’ may indicate characteristics of visible changes, such as static or dynamic characteristics of the objects existing in the video for a predetermined time, as well as the noticeable characteristics of time-lapse variation of an unnatural object. Here, the ‘unnatural object’ indicates an object that shows the noticeable characteristics of time-lapse variation that are different from other objects among the plurality of objects. For example, in a case where there is a plurality of extracted objects, if only one of the plurality of objects moves on a different path from other objects, the only one object may be called the unnatural object. Here, the moving on the different movement path from other objects is the noticeable characteristics of time-lapse variation between the plurality of objects.

Then, a summary image is generated in 509, which includes indication symbols that visualize noticeable characteristics of time-lapse variation of each of the plurality of objects identified for each of the plurality of objects. In such a case, the ‘indication symbol’ may be expressed with a trace line that indicates a movement path of the object, an arrow that indicates a movement direction of the object, a thickness of a line that indicates a movement speed of the object, a figure that indicates an appearance of the object, a figure that indicates a disappearance of the object, and a figure that indicates a size of the object. Also, the ‘indication symbol’ may be expressed in a manner of blurring the object in a case where changes of the noticeable characteristics of time-lapse variation of each of the plurality of the objects are similar to thereby be overlapped, but the method may be expressed in various manners, and exemplary embodiments are not limited thereto. In the exemplary embodiment above, since the movement paths of other objects are similar to be overlapped, the indication symbol may be expressed by blurring other objects. Then, the movement path of the unnatural object, i.e., one object that moves on the different path from other objects, may be shown precisely so that monitors or observers may intuitively check objects to be focused on.

Then, the generated summary image is stored in 506. The generated summary image may be temporarily or permanently stored in storage media, etc.

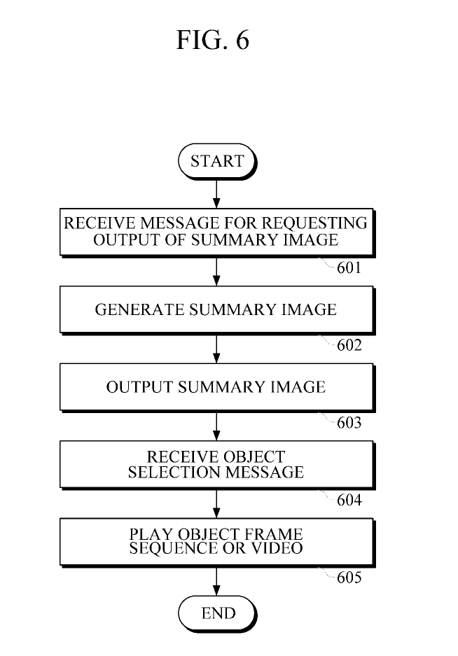

FIG. 6 is a flowchart illustrating a video summary method according to yet another exemplary embodiment.

Referring to FIG. 6, a message for requesting output of a summary image is received in 601. For example, the message may be a start time and an end time of a video for a predetermined time so as to generate the summary image.

Then, if the video to generate the summary image for a predetermined time according to the message has been determined, the video for a predetermined time may be generated in 602 according to the video summary methods as illustrated in FIG. 4 or 5.

Then, the generated summary image is output in 603. The generated summary image may be output through a display of electronic devices that have a main function of filming videos, such as a digital camera or a camcorder, but exemplary embodiments are not limited thereto. Preferably, the summary image may be output, which is generated in a CCTV console, so as to monitor and observe the CCTV camera.

Then, an object selection message is received in 604. The object within the generated summary image may be selected. Alternatively, in a case where there is a plurality of objects within the generated summary image, a specific object may be selected.

Then, if the object is selected, the original frame sequence where the object is included may be played. Alternatively, if a specific object is selected among the plurality of objects, the original frame sequence where the specific object is included may be played, or a synthesis frame sequence generated with regard to the specific object may be played in 605.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A video summary apparatus, comprising:
an object extractor configured to extract an object by separating a background from original frames, respectively, of a video for a predetermined time;
an object analyzer configured to analyze, according to an original frame sequence of the original frames, the object extracted by the object extractor and identify noticeable characteristics of time-lapse variation of the object; and
a summary image generator configured to generate a summary image including an indication symbol that visualizes the noticeable characteristics of the object identified by the object analyzer.

2. The video summary apparatus of claim 1, wherein the noticeable characteristics comprises one or more of a movement path, a movement speed, a size, an appearance, and a disappearance.

3. The video summary apparatus of claim 1, wherein the indication symbol is expressed by using one or more of:
a trace line that indicates a movement path of the object;
an arrow that indicates a movement direction of the object;
a thickness of a line that indicates a movement speed of the object; and
figures that indicate an appearance, disappearance, and size of the object.

4. The video summary apparatus of claim 1, wherein the summary image generator is configured to generate the summary image by setting a time point, in which the noticeable characteristics of the object are changed, as a standard time point for generating the summary image.

5. The video summary apparatus of claim 1, further comprising:
a video player configured to play the original frame sequence where the object is included, in response to selection of the object within the generated summary image.

6. The video summary apparatus of claim 1, further comprising, in a case where there is a plurality of objects extracted by the object extractor:
an object frame sequence synthesizer configured to synthesize a frame sequence of each of the plurality of the objects and a frame sequence of the background so as to generate a synthesis frame sequence,
wherein:
the object analyzer is configured to analyze each of the plurality of the extracted objects according to the original frame sequence or the synthesis frame sequence and identify the noticeable characteristics of each of the plurality of objects; and
the video summary image generator is configured to generate a summary image including an indication symbol that visualizes the identified noticeable characteristics of each of the plurality of objects.

7. The video summary apparatus of claim 6, wherein in a case where there is the plurality of objects extracted by the object extractor, the noticeable characteristics comprises the noticeable characteristics of an unnatural object, which are different from the noticeable characteristics of other objects.

8. The video summary apparatus of claim 6, wherein in a case where there is the plurality of objects extracted by the object extractor, changes of the noticeable characteristics are similar to be overlapped such that the indication symbol is blurred.

9. The video summary apparatus of claim 6, further comprising:
a video player configured to, in response to a selection of a specific object within the generated summary image, play one of the synthesis frame sequence and the original frame sequence that includes the object with regard to the specific object.

10. A video summary method, comprising:
(a) extracting an object by separating a background from original frames, respectively, of a video for a predetermined time;
(b) analyzing, according to an original frame sequence of the original frames, the object extracted by the object extractor and identifying noticeable characteristics of time-lapse variation of the object; and
(c) generating a summary image including an indication symbol that visualizes the identified noticeable characteristics of the object.

11. The video summary method of claim 10, wherein the noticeable characteristics comprises one or more of a movement path, a movement speed, a size, an appearance, and a disappearance.

12. The video summary method of claim 10, wherein the indication symbol is expressed by using one or more of:
a trace line that indicates a movement path of the object;
an arrow that indicates a movement direction of the object;
a thickness of a line that indicates a movement speed of the object; and
figures that indicate an appearance, disappearance, and size of the object.

13. The video summary method of claim 10, wherein (c) comprises generating the summary image by setting a time point, in which the noticeable characteristics of the object are changed, as a standard time point for generating the summary image.

14. The video summary method of claim 10, further comprising:
(e) playing the original frame sequence where the object is included, in response to selection of the object within the generated summary image.

15. The video summary method of claim 10, further comprising, prior to (b), in a case where there is a plurality of objects extracted in (a):
(d) synthesizing a frame sequence of each of the plurality of objects and a frame sequence of the background so as to generate a synthesis frame sequence,
wherein:
(b) comprises analyzing each of the plurality of extracted objects according to the original frame sequence or the synthesis frame sequence and identifying the noticeable characteristics of each of the plurality of objects; and
(c) comprises generating the summary image including an indication symbol that visualizes the identified noticeable characteristics of each of the plurality of objects.

16. The video summary method of claim 15, wherein in a case where there is the plurality of objects extracted by the object extractor, the noticeable characteristics comprises the noticeable characteristics of an unnatural object, which are different from the noticeable characteristics of other objects.

17. The video summary method of claim 15, wherein in a case where there is the plurality of objects extracted by the object extractor, changes of the noticeable characteristics are similar to be overlapped such that the indication symbol is blurred.

18. The video summary method of claim 15, further comprising:
(e) in response to a selection of a specific object within the generated summary image, playing one of the synthesis frame sequence and the original frame sequence that includes the object with regard to the specific object.

19. The video summary method of claim 11, further comprising, prior to (a):
determining a predetermined time in response to a request for generating the summary image for a predetermined time interval.

20. A computer readable recording medium having embodied thereon a computer program for executing a method comprising:
(a) extracting an object by separating a background from original frames, respectively, of a video for a predetermined time;
(b) analyzing, according to an original frame sequence of the original frames, the object extracted by the object extractor and identifying noticeable characteristics of time-lapse variation of the object; and
(c) generating a summary image including an indication symbol that visualizes the identified noticeable characteristics of the object.
